(19) United States
(12) Patent Application Publication
(10) Pub. No.: US 2018/0094467 A1
(43) Pub. Date: Apr. 5, 2018

(54) REPLACEABLE ACTUATOR TIP

(71) Applicant: Sikorsky Aircraft Corporation, Stratford, CT (US)

(72) Inventors: Jonathan Bremmer, Glastonbury, CT (US); Darryl Mark Toni, Madison, CT (US); David J. Goldschmidt, North Haven, CT (US); James S. Giampapa, Oxford, CT (US); Jeffrey G. Sauer, Woodbury, CT (US)

(21) Appl. No.: 15/549,038

(22) PCT Filed: Dec. 11, 2015
(86) PCT No.: PCT/US2015/065160

§ 371 Date: Aug. 4, 2017

Related U.S. Application Data
(60) Provisional application No. 62/116,024, filed on Feb. 13, 2015.

(51) Int. Cl. E05D 7/10; E05D 5/10

(52) U.S. Cl. CPC E05D 7/1005; E05D 2007/1027; E05D 5/10

(57) ABSTRACT

A pin of a hinge system movable between a first position and a second position is provided, wherein in the first position, the pin is received within a first component and a second component. The pin includes a cylindrical body coupled to an actuator for movement along an axis between the first position and the second position. A tip is removably attached to an end of the cylindrical body. The tip is configured to contact at least one of the first component and the second component when the pin is in the first position.

### FEDERAL RESEARCH STATEMENT

This invention was made with Government support under Contract No. N00019-06-C-0081 with the United States Navy. The Government has certain rights in the invention.

### BACKGROUND OF THE INVENTION

Exemplary embodiments of the invention relate to a blade fold assembly for a rotary wing aircraft, and more particularly, to an actuator pin movable between an extended and a retracted position during operation of a blade fold system.

The flight capabilities of rotary-wing aircrafts make them effective for a wide variety of missions; however, operation of rotary-wing aircraft in certain environments may be limited by the overall structural envelopes thereof. The radial dimensions of a rotary-wing aircraft main rotor assembly results in a rotary-wing aircraft having relatively large structural envelopes which may impact its utility in some environments. For example, space on a ship or vessel is generally at a premium and the structural envelope of a rotary wing aircraft may require a significant allocation of such limited space. Furthermore, strategic and tactical considerations in the military utilization of rotary-wing aircrafts has led to a requirement for rotary-wing aircrafts having main rotor assemblies that may be readily reconfigured for rapid deployment, routine transport, and/or stowage by reducing the structural envelope.

One way to reduce the structural envelope of rotary-wing aircraft to facilitate rapid deployment, routine transport, stowage, and reduce the vulnerability thereof to environmental conditions is to design the main rotor assembly so that the main rotor blades fold relative to the main rotor hub. Typically a portion of the rotor blade is pivotally mounted to an adjacent rotor hub with one or more pins for example. The high contact loads applied to the pin when the pin retains the rotor blade in an extended position may cause damage during use. For example, offsets between the bushings through which the pin extends cause high frictional loads that wear the material as well as gall and gouge the pin.

### BRIEF DESCRIPTION OF THE INVENTION

According to one embodiment of the invention, a pin of a hinge system movable between a first position and a second position is provided, wherein in the first position, the pin is received within a first component and a second component. The pin includes a cylindrical body coupled to an actuator for movement along an axis between the first position and the second position. A tip is removably attached to an end of the cylindrical body. The tip is configured to contact at least one of the first component and the second component when the pin is in the first position.

In addition to one or more of the features described above, or as an alternative, in further embodiments the actuator is a linear actuator having a piston arranged coaxially with the pin.

In addition to one or more of the features described above, or as an alternative, in further embodiments the actuator is a rotary actuator.

In addition to one or more of the features described above, or as an alternative, in further embodiments the first end of the cylindrical body is connected to the actuator.

In addition to one or more of the features described above, or as an alternative, in further embodiments the tip is formed from a sacrificial metallic material.

In addition to one or more of the features described above, or as an alternative, in further embodiments the tip is threadably attached to the cylindrical body.

In addition to one or more of the features described above, or as an alternative, in further embodiments the tip is configured to receive and couple to a post extending from the end of the cylindrical body.

According to one embodiment of the invention, a hinge assembly is provided including a first component and a second component. The second component is coupled to and movable relative to the first component about a hinge axis between a first position and a second position. A hinge system is configured to selectively couple and decouple the first component and the second component. The hinge system includes an actuator and a pin having a cylindrical body coupled to the actuator for movement along an axis between an extended position and a retracted position. When the pin is in the extended position, the first and second component are coupled, and when the pin is in the retracted position, the second component is decoupled from the first component. A tip is removably attached to an end of the cylindrical body. The tip is configured to contact at least one of the first component and the second component when the pin is in the extended position.

In addition to one or more of the features described above, or as an alternative, in further embodiments the actuator is a linear actuator having a piston arranged coaxially with the pin

In addition to one or more of the features described above, or as an alternative, in further embodiments the actuator is a rotary actuator.

In addition to one or more of the features described above, or as an alternative, in further embodiments the tip is formed from a sacrificial metallic material.

In addition to one or more of the features described above, or as an alternative, in further embodiments the tip is threadably attached to the cylindrical body.

In addition to one or more of the features described above, or as an alternative, in further embodiments the tip is configured to receive and couple to a post extending from the end of the cylindrical body.

In addition to one or more of the features described above, or as an alternative, in further embodiments the hinge assembly includes a blade fold system such that the first component is a sleeve and the second component is a blade cuff.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of a rotary wing aircraft;

FIG. 2A is a top view of the main rotor system of the rotary wing aircraft of FIG. 1;

FIG. 2B is a top view of a main rotor blade assembly of a rotary wing aircraft including a blade fold system;

FIG. 3 is a perspective view of an example of a rotary win aircraft having a plurality of main rotor blade assemblies arranged in a folded configuration;

FIG. 4 is a side view of a portion of a blade fold system of a rotary wing aircraft according to an embodiment of the invention;

FIG. 5 is a perspective view of a pin of the blade fold system according to an embodiment of the invention;

FIG. 6 is a perspective view of the pin of the blade fold system in an extended position according to an embodiment of the invention; and

FIG. 7 is a side view of the pin of the blade fold system in a retracted position according to an embodiment of the invention.

The detailed description explains embodiments of the invention, together with advantages and features, by way of example with reference to the drawings.

### DETAILED DESCRIPTION OF THE INVENTION

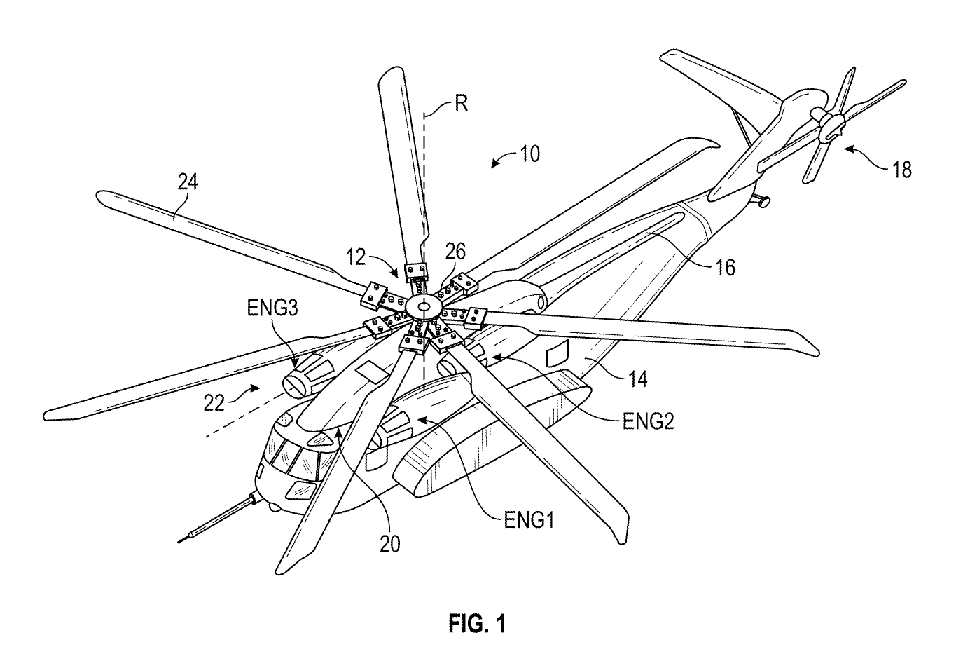

FIG. 1 schematically illustrates a rotary-wing aircraft 10 having a main rotor system 12. The aircraft 10 includes an airframe 14 having an extending tail 16 which mounts a tail rotor system 18, such as an anti-torque system, a translational thrust system, a pusher propeller, or a rotor propulsion system for example. Power is transferred from one or more engines ENG to a power transmission gearbox 20, to drive the main rotor system 12 about a respective axis of rotation R. Although a particular rotary wing aircraft configuration is illustrated and described in the disclosed embodiment, other configurations and/or machines, such as a high speed compound rotary wing aircraft with supplemental translational thrust systems, a dual contra-rotating, coaxial rotor system aircraft, and a turbo-prop, tilt-rotor or tilt-wing aircraft for example, will also benefit from the present invention.

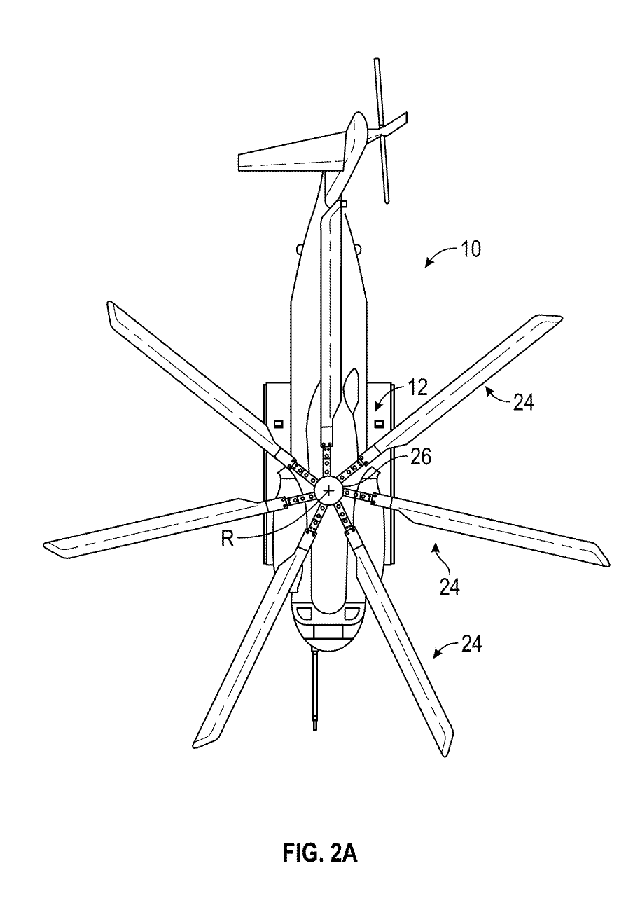

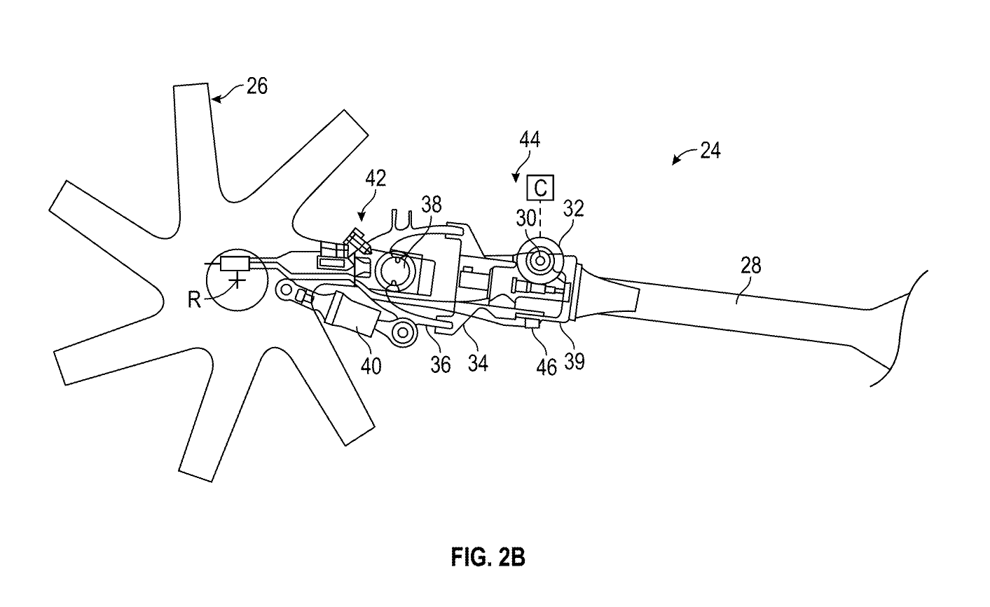

Referring now to FIG. 2A, the main rotor system 12 includes a plurality of rotor blade assemblies 24, each of which is mounted to a rotor hub 26 for rotation about the axis of rotation R. Although seven rotor blade assemblies 24 are illustrated, it should be understood that the main rotor system 12 may include any number of rotor blade assemblies 24. Furthermore, since each main rotor blade assembly is generally alike, only one main rotor blade assembly will be described in detail herein with the understanding that the description is generally applicable to each of the rotor blade assemblies 24.

As illustrated in FIG. 2B, each rotor blade assembly 24 generally includes a main rotor blade 28, a hinge assembly 30, an actuator 32, a sleeve 34, a yoke 36, an elastomeric bearing 38, and a blade lock assembly 40. The yoke 36 is mounted to the rotor hub 26 through the elastomeric bearing 38 such that the rotor blade assembly 24 may move in pitch, flap, and lead/lag motions as generally understood. The rotor blade assembly 24 may additionally include a damper assembly 42 configured to react against the lead/lag motions of the blade assembly 24 to damper vibration thereof.

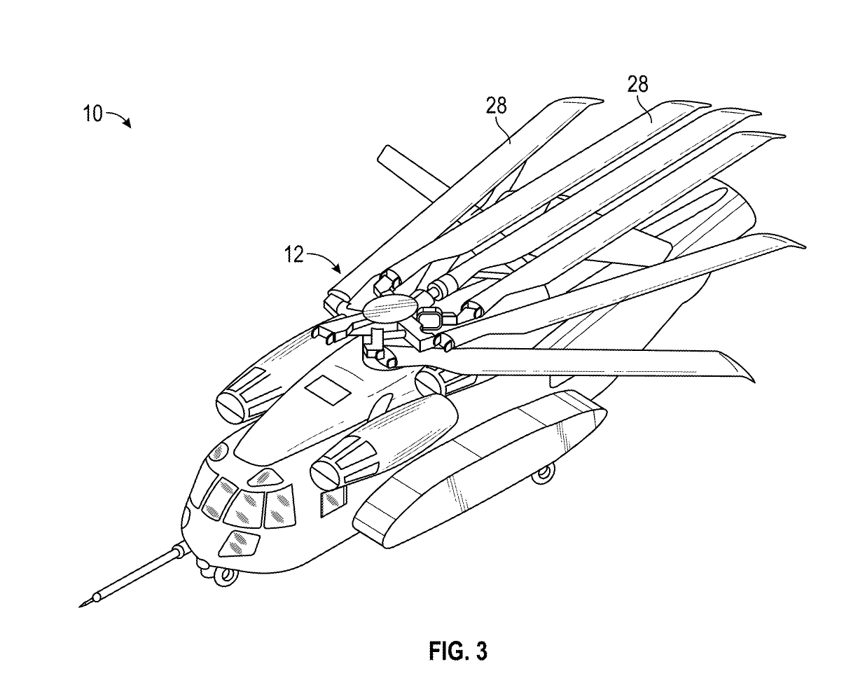

An example of a rotor blade fold system 44 for a rotor blade assembly 24 is illustrated in more detail. The illustrated, non-limiting blade fold system 44 generally includes the blade lock assembly 42, the actuator 32, a retractable blade retaining pin 46, and a blade fold controller (illustrated schematically at C) to selectively position each rotor blade assembly 24 in a particular folded position to minimize the envelope of the aircraft for stowage (FIG. 3).

The blade lock assembly 42 is mounted to the rotor hub 26 and selectively engages the yoke 36. The blade lock assembly 42 positions each blade assembly 24 in its blade fold position which includes positioning each yoke 36 in a predetermined lead/lag and pitch position and a predetermined rotor blade fold angle. Once the pitch lock assembly 42 engages the yoke 36, the blade retaining pin 46 is moved to a retracted position and the actuator 32 rotates each rotor blade 28 about the hinge assembly 30 to a predetermined blade fold angle.

With reference now to FIGS. 4-7, a pin 50 of the blade fold system 44, such as the retractable blade retaining pin 33 for example, is illustrated in more detail. Although the pin 50 is illustrated and described herein with reference to a main rotor blade assembly 24, in other embodiments, the pin 50 may be configured as part of a tail rotor blade assembly of a rotary wing aircraft 10, a pylon fold system, or any lug/clevis hinge or lock joint which is engaged by insertion of the pin 50. The pin 50 has a generally cylindrical body 52 a portion of which, such as a first end 54 for example, is connected to an actuator 56.

A tip 60 is arranged at a second, opposite end 58 of the cylindrical body 52. As shown, the tip 60 has a generally frustoconical shape; however, tips 60 having other shapes, such as a conical or semispherical shapes for example, are within the scope of the invention. The tip 60 is generally formed as a sacrificial part of the pin 50, and therefore may be formed from any number of materials, including, but not limited to, beryllium copper, nickel aluminum bronze, ToughMet®, or other suitable metallic materials.

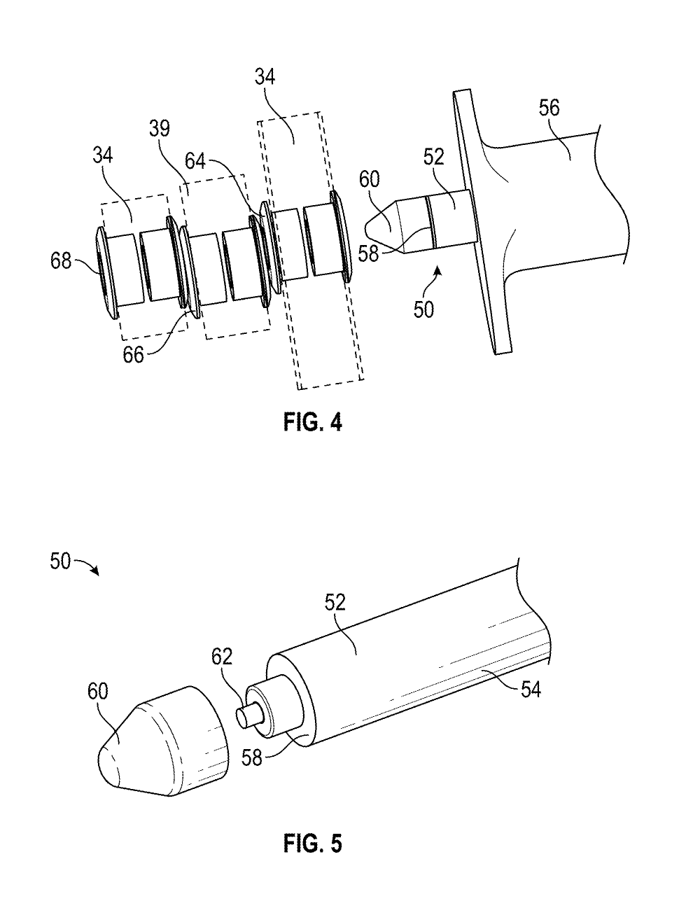

The tip 60 of the pin 50 may be removably attached to the pin body 52, as shown in FIG. 5. For example, in the illustrated, non-limiting embodiment, the tip 60 has an opening (not shown) formed therein generally complementary to and configured to receive a post 62 extending from the second end 58 of the pin body 52. The post 62 may be slidably inserted, or alternatively, threadably attached to the tip 60. However, other connection means for removably attaching the tip 60 to the pin body 52, such as a fastener for example, are within the scope of the invention. In one embodiment, the connection formed between the tip 60 and the pin body 52 is configured to limit unintentional separation of the tip 60 from the body 52 during operation of the blade fold system 44. For example, the fit formed between the opening in the tip 60 and the post 62 received therein may be designed to prevent separation of the tip 60 from the body 52 during operation of the blade fold system 44.

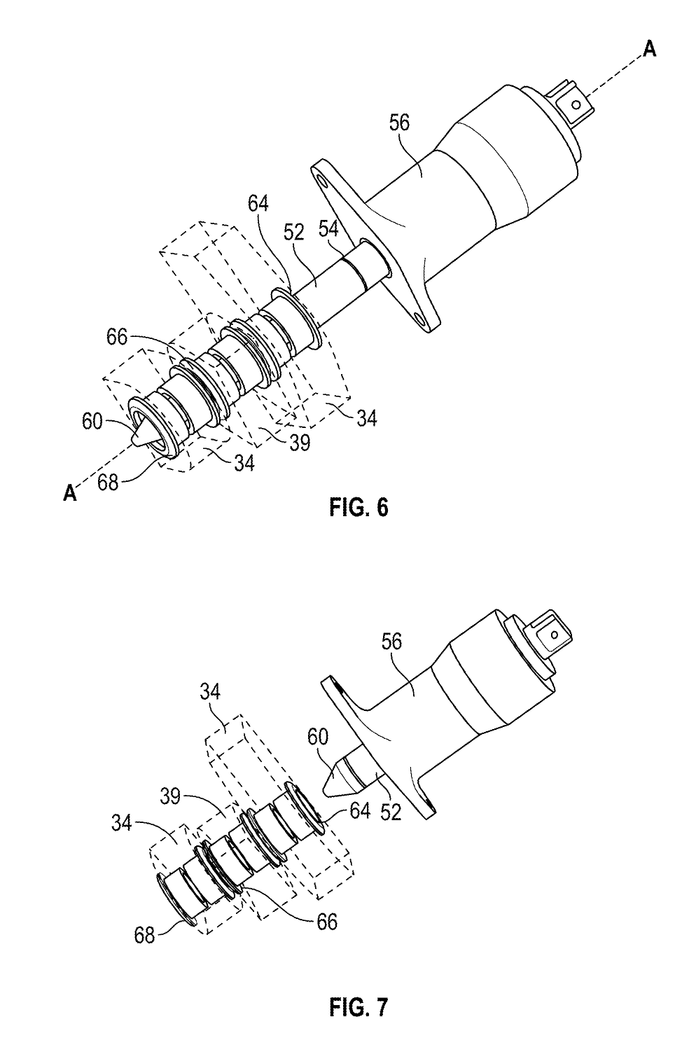

Because a portion of the pin 50 is connected to an adjacent actuator 56, the pin 50 is movable between a first, extended position (FIG. 6) and a second, retracted position (FIG. 7). In the illustrated, non-limiting embodiment, the actuator 56 is a linear actuator having a piston or shaft (not shown) arranged coaxially with the pin 50 for movement along an axis A. In another embodiment, the actuator 56 is a rotary actuator wherein rotation of the actuator piston (not shown) may similarly cause the pin 50 to move along an axis A.

The pin 50 is movable to selectively couple and decouple two or more adjacent components of the rotor blade assembly 24. In one embodiment, the pin 50 is configured to couple a blade cuff 39 (FIG. 2B) and sleeve 34 of the rotor blade assembly 24 to control movement of the rotor blade 28 about an axis defined by the hinge assembly 30. When the rotor blade is in a non-folded configuration, a first opening 64 formed in the sleeve 34 and a second opening 66 formed in the blade cuff 39 are generally aligned. In embodiments where the sleeve 34 is a clevis, a third opening 68 formed in an adjacent portion of the sleeve 34 may be aligned with the first and second openings 64, 66. When in the retracted position, the pin 50 does not extend through any of the plurality of openings 64, 66, 68, as shown in FIG. 7, thereby allowing the blade cuff 39 and rotor blade 28 to freely rotate about a hinge axis. When extended, the pin 50 is received at least partially within each of the plurality of aligned openings 64, 66, 68, thereby limiting movement of the blade cuff 39 relative to the sleeve 34.

When the pin 50 is extended, the tip 60 of the pin 50 is at least partially in contact with a surface of one of the plurality of openings, such as the third opening 68 for example. As a result, the tip 60 is configured to experience significant contact pressure. For example, when the openings 64, 66, 68 of the adjacent components are slightly misaligned, the frictional forces applied to the pin 50 significantly increase. By adequately designing the contour of the tip 60, the galling and gouging caused by the high friction loads may be directed towards the tip 60, such that only the tip 60, and not the pin 50 and actuator 56, need replacing.

Inclusion of a pin 50 having a removable tip 60 in a blade fold system 42 reduces the overall maintenance required for an aircraft 10 by limiting the area where damage occurs to the easily replaceable tip 60 of the pin 50. In addition, the remainder of the blade fold system have improved durability, by reducing the galling and wear that may occur between the extended pin 50 and the components through which the pin 50 extends.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A pin of a hinge system movable between a first position and a second position, wherein in the first position, the pin is received within a first component and a second component, the pin comprising:
a cylindrical body coupled to an actuator for movement along an axis between the first position and the second position; and
a tip removably attached to an end of the cylindrical body, the tip being configured to contact at least one of the first component and the second component when the pin is in the first position.

2. The pin according to claim 1, wherein the actuator is a linear actuator having a piston arranged coaxially with the pin.

3. The pin according to claim 1, wherein the actuator is a rotary actuator.

4. The pin according to claim 1, wherein the first end of the cylindrical body is connected to the actuator.

5. The pin according to claim 1, wherein the tip is formed from a sacrificial metallic material.

6. The pin according to claim 1, wherein the tip is threadably attached to the cylindrical body.

7. The pin according to claim 1, wherein the tip is configured to receive and couple to a post extending from the end of the cylindrical body.

8. A hinge assembly comprising:
a first component;
a second component coupled to the first component and movable relative to the first component about a hinge axis between a first position and a second position;
a hinge system configured to selectively couple and decouple the first component and the second component, the hinge system including:
an actuator;
a pin having a cylindrical body coupled to the actuator for movement along an axis between an extended position and a retracted position, wherein when the pin is in the extended position, the first component and second component are coupled and when the pin is in the retracted position, the second component is decoupled from the first component; and
a tip removably attached to an end of the cylindrical body, the tip being configured to contact at least one of the first component and the second component when the pin is in the extended position.

9. The hinge assembly according to claim 8, wherein the actuator is a linear actuator having a piston arranged coaxially with the pin.

10. The hinge assembly according to claim 8, wherein the actuator is a rotary actuator.

11. The hinge assembly according to claim 8, wherein the tip is formed from a sacrificial metallic material.

12. The hinge assembly according to claim 8, wherein the tip is threadably attached to the cylindrical body.

13. The hinge assembly according to claim 8, wherein the tip is configured to receive and couple to a post extending from the end of the cylindrical body.

14. The hinge assembly according to claim 8, wherein the hinge assembly comprises a blade fold system, and wherein the first component is a sleeve and the second component is a blade cuff.
